(19) United States
(12) Patent Application Publication
(10) Pub. No.: US 2025/0236043 A1
(43) Pub. Date: Jul. 24, 2025

(54) SAWMILL BED ASSEMBLY

(71) Applicant: Norwood Industries Inc., Barrie (CA)

(72) Inventor: Brian SHELLSWELL, Barrie (CA)

(73) Assignee: Norwood Industries Inc., Barrie (CA)

(21) Appl. No.: 19/023,571

(22) Filed: Jan. 16, 2025

(30) Foreign Application Priority Data
Jan. 19, 2024 (CA) 3226701

(51) Int. Cl. B27B 29/00; B27B 15/02

(52) U.S. Cl. CPC B27B 29/00; B27B 15/02

(57) ABSTRACT

A sawmill, a sawmill kit, I and a method for securing one or more components to a sawmill comprises fastening the one or more components between two or more metal plates and securing the plates to the bed directly and further through a plurality of mounting brackets. The components may include one or more of a toe board, a log rest, and a log turner. The components may be hydraulically actuated, and the hydraulics or other actuation systems may be attached to the side of a metal plate or disposed between the metal plates. The method reduces material usage, provides ease of assembly, and saves manufacturing and shipping costs over the prior art.

### FIELD

This application claims priority to Canadian Application No. 3226701, filed Jan. 19, 2024, which is hereby incorporated herein by reference in its entirety.

### BACKGROUND OF THE INVENTION

Sawmills have a bed for holding logs when cutting. The bed typically has two rails parallel to a first axis. A sawmill carriage assembly is moveably fixed to a sawmill bed. The sawmill bed receives a log, such that the log extends longitudinally along to the length of the sawmill bed. The sawmill carriage assembly supports a saw head, a saw engine, a saw controller, and a saw lubricator apparatus. The sawhead has the saw mounted thereon, and the saw is used to mill the log into lumber. The carriage moves along rails on the bed. The rails may be held in place by cross-bunks.

A sawmill bed may include several components to facilitate easy and safe cutting of a log. These components are affixed to the bed of the sawmill such that they can interact with the log when the log is placed on the cross-bunks of the bed. Some of these components include a log turner, a toe board, and a log rest. A log turner is used to grab the log and rotate it on the bed, so that it can be positioned properly for cutting. A toe board compensates for the natural taper of the log, so that the planks cut from it are not tapered. A log rest provides a surface that the log can lean against so that it does not shift or roll unintentionally.

Current sawmills may attach the components to rails that are attached to the bed or may mount the components on the cross-bunks. The sawmills must use thick metal plates as cross-bunks to handle all the weight/forces of the log and components. These thick plates are heavy and may need to be welded in place. Welding is expensive and requires expertise for assembly of the sawmill and can fail unexpectedly. Additionally, the heavy plates increase the cost of materials and manufacturing, as well as the cost of shipping. Further, the requirement for welding reduces ease of assembly.

Thus, there is a need in the art for an assembly that allows the components to be secured to the sawmill bed without using heavy, thick metal plates. Further, there is a need in the art for a way to secure the components without welding or similar difficult methods.

### SUMMARY OF THE INVENTION

The sawmill of the invention has a bed having a first rail and a second rail positioned parallel to each other, a carriage having horizontal movement along the bed,

a sawhead attached to the carriage, and a cross-bunk having a first end and a second end, the first end attached to the first rail and the second end attached to the second rail, the cross bunk comprising an assembly of laminated sheets comprising two or more rigid plates horizontally extending from the first end to the second end. One or more components for the sawmill are secured between the two or more horizontally extending rigid plates by component fasteners, wherein the component fasteners also fasten the two or more horizontally extending rigid plates to each other.

The one or more components for the sawmill may be supported and stabilized by the horizontally extending rigid plates, with the one or more components for the sawmill are movable within the horizontally extending rigid plates. The components may be one or more of a toe board assembly, a log rest assembly; and a log turner assembly.

Where the component is a toe board assembly, the toe board assembly may have a toe board and a hydraulic assembly, the hydraulic assembly comprising a top end and a bottom end, the top end secured to a top fastener, the top fastener secured to the two or more rigid plates, and a bottom fastener, the bottom fastener secured to the toe board. The the toe board assembly may further comprise a slot extending vertically, and the top fastener is received through the slot to allow a vertically slideable relation between the slot and the top fastener. The slot and the top fastener may be sized to prevent horizontal movement of the toe board. The assembly of laminated sheets may be sized to prevent horizontal movement of the toe board.

A component may be a log rest assembly having a log rest, and a hydraulic assembly, the hydraulic assembly having a top end and a lower end, the top end secured to a top of the log rest and the lower end secured to the two or more rigid plates. The laminated sheets may be sized to prevent horizontal movement of the log rest.

A component may be a log turner assembly, the log turner assembly comprising a log turning chain and a motor, the motor secured to the two or more rigid plates, the motor providing structural integrity to the assembly of laminated sheets.

The horizontally extending rigid plates may be fastened to the rails with rigid brackets. The two or more horizontally extending rigid plates may be made of steel.

The fasteners may be bolts and nuts. Spacers attached to the fasteners may tightly fit the space between the laminated sheets and providing structural integrity to the assembly of laminated sheets.

Also taught is a method for securing one or more components to a sawmill of claims 1 to 14, comprising fastening two or more horizontally extending rigid plates to the bed of the sawmill, and securing one or more components for the sawmill in between the two or more horizontally extending rigid plates. The one or more components for the sawmill may be supported and stabilized by the horizontally extending rigid plates; and

the one or more components for the sawmill may be freely movable within the horizontally extending rigid plates.

The method may also secure and support the rigid plates. The fastening may be by any fastening means known in the art, such as bolts and nuts, rivets, slatwall hooks, or a combination thereof.

Also taught is a kit of parts for constructing a sawmill of the invention.

According to one aspect of the invention, a method for securing one or more components to a sawmill is provided. Sawmill components may be internally gripped or secured within the two or more horizontally extending rigid plates. In some embodiments, the plates are made of steel. In some embodiments, the components are secured within the horizontally extending rigid plates with any fastening means known in the art, such as bolts and nuts, rivets, slatwall hooks, or a combination thereof.

In some embodiments, the two or more horizontally extending rigid plates are substantially identical. In some embodiments, the one or more components comprises one or more of: a toe board, a log rest, and a log turner. In some embodiments, the each of the one or more components are actuated by hydraulic systems. In some embodiments, the hydraulic systems are fastened to the horizontally extending rigid plates.

### BRIEF DESCRIPTION OF THE DRAWINGS

Reference will now be made, by way of example, to the accompanying drawings which show exemplary embodiments of the present application, and in which:

FIG. 1 is an perspective view of an exemplary laminated plate assembly containing a hydraulic actuated log rest and toe board.

FIG. 2 is a top-down plan view of the laminated plate assembly of FIG. 1.

FIG. 3 is an perspective view of an exemplary laminated plate assembly containing a hydraulic actuated log turner.

FIG. 4 is a top-down view of the laminated plate assembly of FIG. 3.

FIG. 5 is a perspective view of a sawmill of the invention, incorporating the assemblies of FIGS. 1 to 4.

### DETAILED DESCRIPTION OF PREFERRED EMBODIMENTS

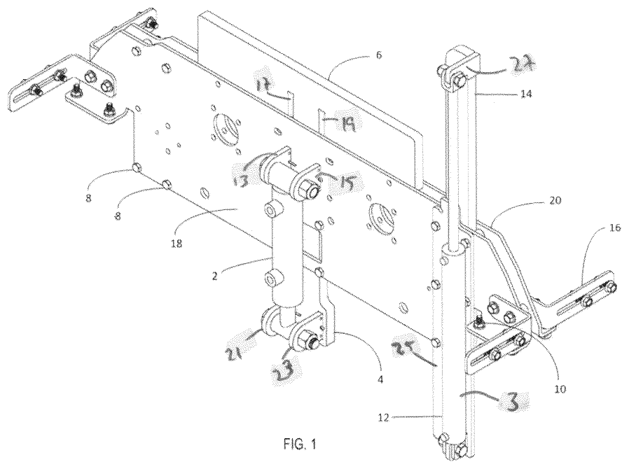

Referring now to FIG. 1, an example component assembly is illustrated comprising a toe board assembly and a log rest assembly both secured to laminated sheets. The sheets may be made of any suitable material known in the field. In some examples, the plates may be made of metal. In some examples, the plates may be made of reinforced resin. In preferred examples, the plates are made of steel, stainless steel, aluminium, or metal alloys.

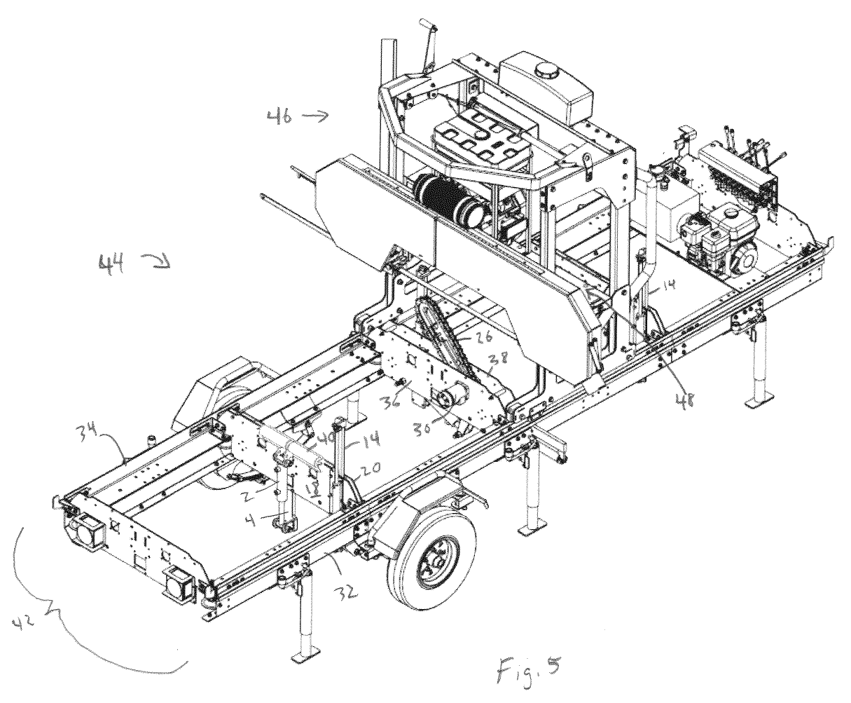

The laminated sheets may be attached to brackets 16 which may attach directly to the bed 42 of the sawmill 44 (see FIG. 5). Alternatively, the laminated sheets may be attached directly to the bed 42 of the sawmill 44. This modular and easily assembled design allows for the metal to be cut out of thin sheets, rather than large blocks of metal which requires welding. The laminated sheets may be made of any suitable material known in the field.

The laminated sheets 18 and 20 are secured with component fasteners, such as bolts 8 and nuts 10, and may include a washer or other spacer 22. FIG. 1 serves as an example assembly, and a person of skill in the art understands that the laminated sheets 18 and 20 may be fastened by other component fasteners, such as rivets, or screws. In some examples, the assembly may be affixed to the plates by adhesives, a weld, or the like.

Spacers attached to the component fasteners tightly occupy the space between the laminated sheets, thus providing further structural integrity to the assembly of laminated sheets.

A hydraulic assembly 2 is attached to a toe board having a bottom section 4 and a top section 6. Both sections 4 and 6 of the toe board are secured between two laminated sheets 18 and 20, which may be substantially similar or symmetrical.

The assembly functions as a support and guide for the toe board 4, 6. Top fasteners 13 and 15 secure the top of hydraulic assembly 2 to both laminated sheets 18 and 20. Bottom fasteners 21 and 23 secure the bottom of hydraulic assembly 2 to bottom section 4 of the toe board. Hydraulic lines (not shown) attach to hydraulic assembly 2, and an operator can activate the hydraulic system to raise and lower the toe board 4, 6. Raising and lowering the board 4, 6 allows the miller to quickly and easily adjust the height of the log being milled to account for taper (one end of the log being smaller than the other end) so that the milled planks are not tapered.

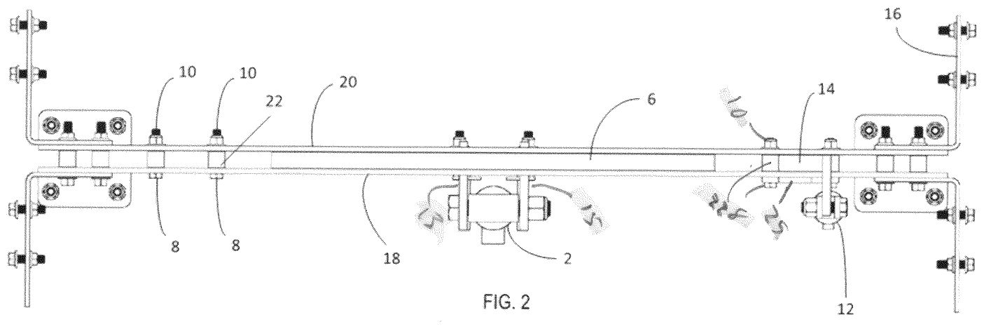

Slots 17 and 19 are found in the top section 6. These slots allow top fasteners 13 and 15 to secure the top of hydraulic assembly 2 to both laminated sheets 18 and 20 without constraining or interfering with the raising and lowering of toe board 4, 6. Top fasteners 13 and 15 thus provide multiple functions. First, they secure hydraulic assembly 2 to both laminated sheets 18 and 20 (see FIG. 2). Second, they assist in maintaining the integrity and strength of the cross-bunk structure of laminated sheets 18 and 20 (FIG. 2). Third they prevent unwanted rotation or horizontal shifting of toe board 4, 6. The toe board may include rollers (40; see FIG. 5) to facilitate easy movement/rolling of the log on the bed 42.

A second hydraulic assembly 12 is similarly attached to a log rest 14 which is also secured between the two laminated sheets 18 and 20. A top end of hydraulic assembly 12 is attached to a protrusion 27 affixed to and at or near the top of log rest 14. A lower portion of hydraulic assembly 12 is attached to a plate 25. Plate 25 is in turn affixed to laminated sheets 18 and 20 using bolts 8 and nuts 10, The assembly thus functions as a support and guide for log rest 14.

Hydraulic lines (not shown) attach to hydraulic assembly 12, and an operator can activate the hydraulic system to raise and lower the log rest 14. Raising and lowering the log rest 14 allows the miller to quickly and easily adjust the height of the log rest 14 so that it is high enough to secure the log in place, but low enough to be clear of the bandblade or chainsaw when milling,

Although FIG. 1 shows the assembly with both the toe board 4, 6 and the log rest 14, a person of skill in the art understands that an assembly may include any singular component or any combination of components

Referring now to FIG. 2, it is clearly shown how the laminated sheets 18 and 20 may be secured with bolts 8, nuts 10, and spacers 22. Further, the toe board 6 and log rest 14 are secured within the laminated sheets 18 and 20, providing stability and support, as well as increasing the strength of the component. The toe board 6 and log rest 14 remain vertically slidable within the bounds of the hydraulic assembly while secured horizontally in between the laminated sheets 18 and 20.

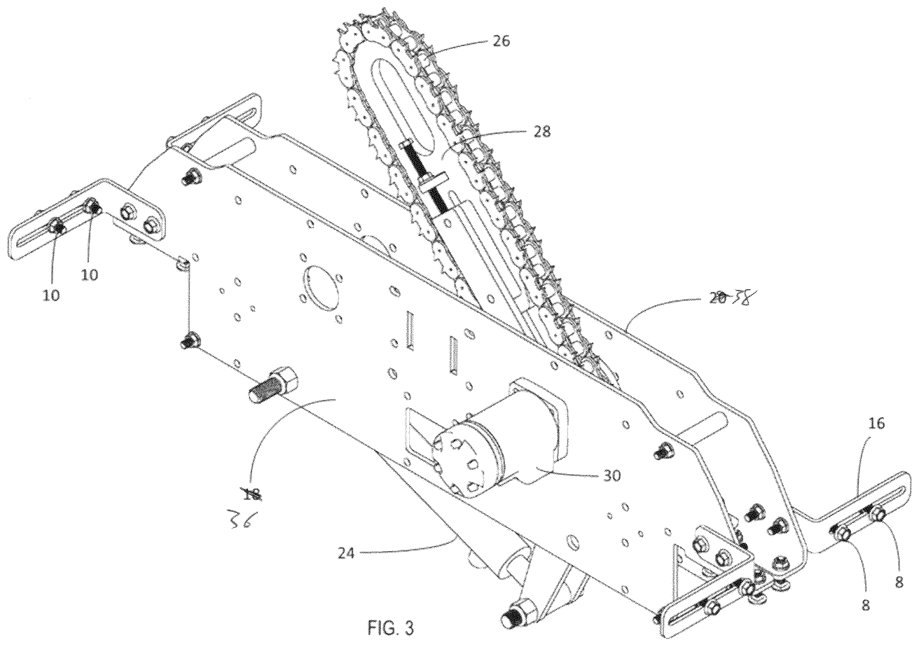

Referring now to FIG. 3, an example component assembly is illustrated comprising a log turner assembly secured to laminated sheets 36 and 38. The assembly functions as a support and stabilizer for the log turner 26.

The log turner 28 is equipped with a rotating chain 26 to grab and roll the log when resting on the sheets. The log turner 28 is attached to a hydraulic assembly 24, as well as a motor 30. hydraulic assembly 24 is contained within the laminated sheets 36 and 38. The laminated sheets 36 and 38 are secured with bolts 8 and nuts 10, and may include a washer or other spacer 22. The laminated sheets 36 and 38 may be fastened by other means, such as rivets, or screws. In some examples, the assembly may be affixed to the plates by adhesives, a weld, or the like.

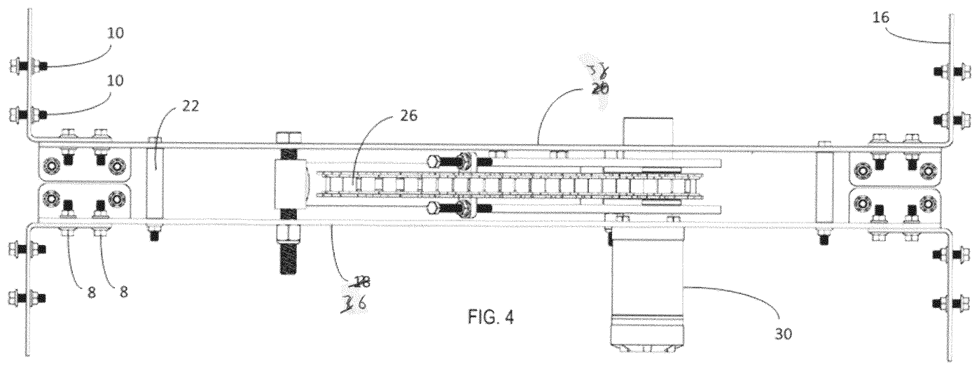

Referring now to FIG. 4, the body of motor 30 is secured to the laminated sheet 26, to the base of log turner 28, and to the laminated sheet 36. The example embodiment similarly may use spacers 22 to ensure adequate pressure on the internal components, such as hydraulic assembly 24 or log turner 26. The motor 30 actuates the log turner 26 to rotate logs to select and change the cutting surface, i.e. the top surface.

By being secured to the laminated sheet 26 the base of log turner 28, and the laminated sheet 20, the motor 30 acts as both a spacer between laminated sheets 36 and 38, and as structure and support for the laminated sheets 26 and 20 in their function as cross-bunks.

FIG. 5 shows the various embodiments of the invention installed in a sawmill bed 42. The bed 42 has two rails 32, 34. Extending between and attached to rails 32, 34 are three sets of two laminated sheets. Between a first set of two laminated sheets 18 and 20 is located hydraulic assemblies 2 attached to a toe board having a bottom section 4 and a top section 6. Both sections 4 and 6 of the toe board are secured between two laminated sheets 26 and 20. A carriage 46 holding a sawhead 48 moves along the bed 42 to mill logs into lumber.

Also between a first set of two laminated sheets 18 and 20 is located a log rest 14 attached to hydraulic assembly 12

Between a second set of two laminated sheets 36 and 38 is located log turner 28. The body of motor 30 is secured to the laminated sheet 26 the base of log turner 28, and the laminated sheet 36.

### Advantages

The assemblies of sheets have multiple functions. First, the assemblies operates as a cross bunk to fix the parallel rails together and hold the bed 42 intact. Second, the assemblies function as a sturdy support for the log to be milled. Third, the assemblies function as a support and guide for the toe board 6 as a support and guide for the log rest 14 (FIG. 1) and as a support and stabilizer for the log turner 26.

Furthermore, top fasteners 13 and 15 of the toe board assembly secure both laminated sheets 18 and 20 to assist in maintaining the cross bunk structure of laminated sheets 18 and 20 (FIG. 2).

Furthermore, bolts 8, nuts 10, and spacers 22 of the log rest assembly secure both laminated sheets 18 and 20 and plate 25 to assist in maintaining the cross bunk structure of laminated sheets 18 and 20 (FIG. 2).

Further, the assembly of bolts 8 nuts 10 fixing the toe board 6 the log rest 14 and the motor of log turner 26 now also become crossbunk structural components, reinforcing the laminated crossbunk sheets within the bed 42 (FIG. 4).

The present invention provides several other advantages. The laminated sheets provide adequate strength to support the components as well as any logs, while being lightweight themselves. Additionally, the laminated sheets are assembled with easy-to-use component fasteners any fastening means known in the art, meaning that customers or users can easily move the sheets and attach them to the brackets or the sawmill bed. The assembly design means that the user does not need to weld the sheets to the bed, and also means that the plates can be shipped flat, rather than assembled. The lowered shipping costs and easy do it yourself assembly makes it an attractive option to consumers seeking to purchase a personal sawmill. The laminated sheets are easier to manufacture, reducing fabrication costs and providing further cost savings to the consumer. The laminated laminated sheets are lighter, reducing shipping costs and providing further cost savings.

While but a single embodiment of the present invention has been herein shown and described, it will be understood that various changes may be made without departing from the scope of the invention.

Unless defined otherwise, all technical terms used herein are intended to have the same meaning as commonly understood by one of ordinary skill in the art.

The scope of the claims should not be limited by the preferred embodiments set forth in the examples, but should be given the broadest interpretation consistent with the description as a whole.

1. A sawmill comprising:
a bed having a first rail and a second rail positioned parallel to each other,
a carriage having horizontal movement along the bed,
a sawhead attached to the carriage,
a cross-bunk having a first end and a second end, the first end attached to the first rail and the second end attached to the second rail, the cross bunk comprising an assembly of laminated sheets comprising:
two or more rigid plates horizontally extending from the first end to the second end and
at least one bolt,
one or more components for the sawmill secured between the two or more horizontally extending rigid plates by the at least one bolt, wherein the at least one bolt also fasten the two or more horizontally extending rigid plates to each other.

2. The sawmill of claim 1, wherein the at least one bolt supports and stabilizes the horizontally extending rigid plates; and the one or more components are movable within the horizontally extending rigid plates.

3. The sawmill of claim 1, wherein the one or more components comprises one or more of:
a toe board assembly;
a log rest assembly; and
a log turner assembly.

4. The sawmill of claim 2, wherein the one or more components comprises one or more of:
a toe board assembly;
a log rest assembly; and
a log turner assembly.

5. The sawmill of claim 1, wherein the one or more components comprises a toe board assembly, the toe board assembly further comprising a toe board operated by a hydraulic assembly, the hydraulic assembly comprising a top end and a bottom end, the top end secured to a top fastener, the top fastener secured to each of the two or more rigid plates, and a bottom fastener, the bottom fastener secured to the toe board.

6. The sawmill of claim 5, wherein the toe board assembly further comprising a vertically extending slot through the toe board, and the top fastener is received through the slot to allow a vertically slideable relation between the toe board and the top fastener.

7. The sawmill of claim 6, wherein the slot and the top fastener are sized to prevent horizontal movement of the toe board.

8. The sawmill of claim 5 wherein the two or more rigid plates are positioned to prevent horizontal movement of the toe board.

9. The sawmill of claim 1, wherein the one or more components comprises a log rest assembly, the log rest assembly comprising a log rest operated by the hydraulic assembly, the top end secured to a top of the log rest and the bottom end secured to each of the two or more rigid plates.

10. The sawmill of claim 9 wherein the two or more rigid plates are positioned to prevent horizontal movement of the log rest.

11. The sawmill of any of claim 1, wherein the one or more components comprises a log turner assembly, the log turner assembly comprising a log turning chain, a chain bar and a motor, the motor secured to the two or more rigid plates, the motor providing structural integrity to the assembly of laminated sheets.

12. The sawmill of claim 1, wherein the horizontally extending rigid plates are fastened to the rails with rigid brackets.

13. The sawmill of claim 1, wherein the two or more horizontally extending rigid plates are made of steel.

14. The sawmill of claim 1, the at least one bolt further comprising a spacer attached to the at least one bolt, the spacer tightly fitting a space between the laminated sheets and providing structural integrity to the assembly of laminated sheets.

15. The sawmill of claim 1, the at least one bolt further comprising spacers attached to the component fasteners, the spacers sized to prevent horizontal movement of the one or more components.

16. A method for securing the one or more components to a sawmill of claim 1, comprising:
fastening the two or more horizontally extending rigid plates to the bed of the sawmill with the at least one bolt;
securing one or more components for the sawmill in between the two or more horizontally extending rigid plates with the at least one bolt, wherein:
the at least one bolt of the one or more components for the sawmill support and stabilize the two or more horizontally extending rigid plates; and
the one or more components for the sawmill are freely movable within the two or more horizontally extending rigid plates.

17. The method of claim 16 wherein the securing also secures and supports the rigid plates.

18. A kit of parts for constructing a sawmill of claim 1 comprising the bed, the carriage, the sawhead, the cross-bunk, the one or more components and the at least one bolt.
